(19) United States
(12) Patent Application Publication
(10) Pub. No.: US 2024/0168554 A1
(43) Pub. Date: May 23, 2024

(54) DOMAIN ADAPTATION METHOD AND SYSTEM FOR GESTURE RECOGNITION

(71) Applicant: Nanjing University of Science and Technology, Nanjing City (CN)

(72) Inventors: Wentao WEI, Nanjing City (CN); Linyan REN, Nanjing City (CN); Bowen ZHOU, Nanjing City (CN)

(73) Assignee: Nanjing University of Science and Technology, Nanjing City (CN)

(21) Appl. No.: 18/515,592

(22) Filed: Nov. 21, 2023

(30) Foreign Application Priority Data
Nov. 23, 2022 (CN) 202211477992.8

(51) Int. Cl. G06F 3/01; G06N 3/08

(52) U.S. Cl. CPC G06F 3/015; G06F 3/017; G06N 3/08

(57) ABSTRACT

An objective of the present disclosure is to provide a domain adaptation method and system for gesture recognition, which relates to the field of gesture recognition technologies. The domain adaptation method for gesture recognition includes: obtaining a to-be-recognized target domain surface electromyography signal of a user; separately inputting the to-be-recognized target domain surface electromyography signal into multiple target domain gesture recognition models, to obtain target domain gesture recognition results under multiple source-specific views, where source domains of training data used by different target domain gesture recognition models are different; and determining a gesture category of the to-be-recognized target domain surface electromyography signal according to the gesture recognition results under multiple source-specific views and a weight under each source-specific view.

### CROSS REFERENCE TO RELATED APPLICATION

This patent application claims the benefit and priority of Chinese Patent Application No. 202211477992.8, filed with the China National Intellectual Property Administration on Nov. 23, 2022, the disclosure of which is incorporated by reference herein in its entirety as part of the present application.

### TECHNICAL FIELD

The present disclosure relates to the field of gesture recognition technologies, and in particular, to a domain adaptation method and system for gesture recognition.

### BACKGROUND

An electromyography gesture recognition system inevitably encounters electrode shift caused by repeatedly wearing a device by a user, muscle fatigue caused by long-term use of the device by the user, and individual differences such as different electrode placement positions, different muscle development, different skin impedance, and different gesture action completion among different users, resulting in significant differences between surface electromyography signals from different users, different sessions, or different muscle fatigue states. From the view of machine learning, the surface electromyography signals from different users, different sessions, or different muscle fatigue states may be considered as different domains, and a data distribution difference between different domains usually causes domain shift. Consequently, training data and test data of a gesture recognition model do not meet a conventional machine learning hypothesis “independent and identically distributed”, which leads to performance degradation of the trained model when recognizing data from a new domain, seriously affecting robustness and a generalization ability of cross-domain gesture recognition of the electromyography gesture recognition system.

Therefore, experts in the field of electromyography human-machine interface widely use a domain adaption learning technology in machine learning to resolve a domain shift problem of electromyography signals induced by various factors. In the field of machine learning, training data of a model is usually considered as source domain data, to-be-recognized new data is considered as target domain data. A goal of domain adaption learning is to minimize a probability distribution difference between a source domain and a target domain and establish a machine learning model that can perform a corresponding task in the target domain. The surface electromyography signal has a multi-source property, that is, surface electromyography data from different users, different sessions, and different muscle fatigue states may be considered as data from different data sources. Therefore, a domain adaption problem in electromyography gesture recognition is essentially a multi-source domain adaption problem. A conventional adaptive learning method between the target domain and a single source domain easily ignores different association between different source domains and the target domain.

### SUMMARY

An objective of the present disclosure is to provide a domain adaptation method and system for gesture recognition, which can fuse results of multiple target domain gesture recognition models under different source-specific views, to improve accuracy of gesture recognition.

To achieve the above objective, the present disclosure provides the following technical solutions.

A domain adaptation method for gesture recognition is provided, including:
obtaining a to-be-recognized target domain surface electromyography signal of a user;
separately inputting the to-be-recognized target domain surface electromyography signal into multiple target domain gesture recognition models, to obtain target domain gesture recognition results under multiple source-specific views, where the target domain gesture recognition models are in one-to-one correspondence with the source-specific views, and a target domain gesture recognition model corresponding to any source-specific view is constructed based on a source domain gesture recognition model of a corresponding source domain and a domain adaption model of a corresponding source-specific view; and
determining a gesture category of the to-be-recognized target domain surface electromyography signal according to the gesture recognition results under multiple source-specific views and a weight under each source-specific view.

Optionally, the source domain gesture recognition model is obtained by training an initial source domain gesture recognition model by using multiple surface electromyography signals under a same source domain; the initial source domain gesture recognition model includes a feature extractor and a gesture classifier; the feature extractor includes a convolutional neural network, a recurrent neural network, and multiple fully connected layers, where the convolutional neural network, the recurrent neural network, and the multiple fully connected layers are sequentially connected; the gesture classifier includes a fully connected layer and a softmax classifier; and the fully connected layer in the gesture classifier includes multiple hidden units;
the domain adaption model includes a target domain feature encoder and a domain discriminator; and a neural network structure of the target domain feature encoder is the same as a neural network structure of a corresponding source domain feature extractor; and
the target domain gesture recognition model includes a trained target domain feature encoder and a trained gesture classifier that correspond to a same source domain.

Optionally, before the obtaining a to-be-recognized target domain surface electromyography signal of a user, the method further includes:
obtaining training surface electromyography signals from multiple subjects, to form a training surface electromyography signal data set, where multiple pieces of training surface electromyography signal data of a same subject in the training surface electromyography signal data set are considered as data under a same source-specific view;
performing label marking on a gesture category corresponding to each frame in multiple training surface electromyography signals in the training surface electromyography signal data set;
constructing multiple initial source domain gesture recognition models;
determining any source domain as a current source domain; and
training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model.

Optionally, the training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model includes:
determining any one of the initial source domain gesture recognition models as a current initial source domain gesture recognition model;
determining a feature extractor in the current initial source domain gesture recognition model as a current feature extractor;
determining a gesture classifier in the current initial source domain gesture recognition model as a current gesture classifier;
inputting multiple training surface electromyography signals under the current source domain into the current feature extractor to obtain multiple current source domain surface electromyography signal deep features, where the current source domain surface electromyography signal deep feature is an output result of the current feature extractor; and
inputting multiple current source domain surface electromyography signal deep features into the current gesture classifier to obtain gesture classification results, where the gesture classification result includes a probability that any current source domain surface electromyography signal is each gesture category.

Optionally, before the obtaining a to-be-recognized target domain surface electromyography signal of a user, the method further includes:
determining the weight under each source-specific view.

Optionally, after the training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model, the method further includes:
constructing a current target domain feature encoder according to a network structure of the trained current feature extractor;
constructing a current domain discriminator by using a parameter of the trained current feature extractor as an initial parameter;
inputting multiple pieces of training surface electromyography signal data of the current source domain into the current target domain feature encoder for encoding, to generate multiple deep encoded features of multiple pieces of training surface electromyography signal data under a current source-specific view; and
inputting multiple deep encoded features of same training surface electromyography signal data and multiple deep encoded features into the current domain discriminator for distinguishing, and updating parameters of the current target domain feature encoder and the current domain discriminator according to a distinguishing result.

Optionally, the determining the weight under each source-specific view includes:
determining a distribution followed by multiple current source domain surface electromyography signal deep features as a first distribution;
determining a distribution followed by multiple target domain surface electromyography signal deep features under the current source domain as a second distribution;
determining a wasserstein distance between the first distribution and the second distribution; and
determining a weight under the current source-specific view according to the wasserstein distance by using a formula

$${ω}_{i} = {e}^{- \frac{{( {V}_{i}^{T} )}^{2}}{2}} ,$$

where ωᵢ represents a weight under an i^{th} source-specific view, and Vᵢ^{T} represents a wasserstein distance corresponding to an i^{th} source domain.

Optionally, the gesture category of the to-be-recognized target domain surface electromyography signal is

$${y}_{j}^{′ T} = arg max ( {\sum }_{i = 1}^{k} {ϖ}_{i} {C}_{i}^{T} ( {F}_{i}^{T} ( {x}_{j}^{′ T} ) ) )$$

where y′ⱼ^{T} represents the gesture category of the to-be-recognized target domain surface electromyography signal, ω̅ᵢ represents a weight under an i^{th} source-specific view, k represents a total quantity of source domains, and Cᵢ^{T}(Fᵢ^{T}(x′ⱼ^{T})) represents a discrimination result of a target domain surface electromyography signal deep feature (Fᵢ^{T}(x′ⱼ^{T}) of a j^{th} target domain surface electromyography signal x′ⱼ^{T} under the i^{th} source-specific view.

A domain adaptation system for gesture recognition is provided, including:
a to-be-recognized target domain surface electromyography signal acquisition module, configured to obtain a to-be-recognized target domain surface electromyography signal of a user;
a gesture recognition result determining module, configured to separately input the to-be-recognized target domain surface electromyography signal into multiple target domain gesture recognition models, to obtain target domain gesture recognition results under multiple source-specific views, where the target domain gesture recognition models are in one-to-one correspondence with the source-specific views, and a target domain gesture recognition model corresponding to any source-specific view is constructed based on a source domain gesture recognition model of a corresponding source domain and a domain adaption model of a corresponding source-specific view; and
a gesture category determining module, configured to determine a gesture category of the to-be-recognized target domain surface electromyography signal according to the gesture recognition results under multiple source-specific views and a weight under each source-specific view.

Optionally, the source domain gesture recognition model is obtained by training an initial source domain gesture recognition model by using multiple surface electromyography signals under a same source domain; the initial source domain gesture recognition model includes a feature extractor and a gesture classifier; the feature extractor includes a convolutional neural network, a recurrent neural network, and multiple fully connected layers, where the convolutional neural network, the recurrent neural network, and the multiple fully connected layers are sequentially connected; the gesture classifier includes a fully connected layer and a softmax classifier; and the fully connected layer in the gesture classifier includes multiple hidden units;
the domain adaption model includes a target domain feature encoder and a domain discriminator; and a neural network structure of the target domain feature encoder is the same as a neural network structure of a corresponding source domain feature extractor; and
the target domain gesture recognition model includes a trained target domain feature encoder and a trained gesture classifier that correspond to a same source domain.

According to specific embodiments provided in the present disclosure, the present disclosure has the following technical effects:
The objective of the present disclosure is to provide a domain adaptation method and system for gesture recognition. A to-be-recognized target domain surface electromyography signal of a user is obtained; the to-be-recognized target domain surface electromyography signal is separately inputted into multiple gesture recognition models, to obtain target domain gesture recognition results under multiple source-specific views, where any target domain gesture recognition model is constructed based on a current source domain gesture recognition model and a domain adaption model under a current source-specific view, any source domain gesture recognition model is obtained by training by using multiple surface electromyography signals under a same source domain and includes a feature extractor and a gesture classifier, the feature extractor is formed by connecting a convolution neural network, a recurrent neural network, and multiple fully connected layers, the gesture classifier is formed by a fully connected layer of multiple hidden units and a softmax classifier, a domain adaption model under any source-specific view is formed by a target domain feature encoder and a domain discriminator, the target domain feature encoder and a current source domain feature extractor have a same neural network structure, and a parameter of the current source domain feature extractor is used as an initial parameter, a target domain feature encoder of a domain adaption model of a current source domain and a current source domain gesture classifier jointly form a target domain gesture recognition model, and source domains of training data used by different target domain gesture category recognition models are different; and a gesture category of the to-be-recognized target domain surface electromyography signal is determined according to the gesture recognition results under multiple source-specific views and a weight under each source-specific view. In the present disclosure, target domain gesture recognition models under different source-specific views are constructed, and fusion is performed based on recognition results of multiple target domain gesture recognition models, to improve accuracy of gesture recognition.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is flowchart of a domain adaptation method for gesture recognition according to Embodiment 1 of the present disclosure;

FIG. 2 is flowchart of a domain adaptation method for gesture recognition according to Embodiment 2 of the present disclosure; and

FIG. 3 is a schematic structural diagram of a gesture category recognition model according to Embodiment 3 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a domain adaptation method and system for gesture recognition, which can fuse results of multiple target domain gesture recognition models under different source-specific views, to improve accuracy of gesture recognition.

In order to make the above objective, features and advantages of the present disclosure clearer and more comprehensible, the present disclosure will be further described in detail below in combination with accompanying drawings and particular implementation modes.

### Embodiment 1

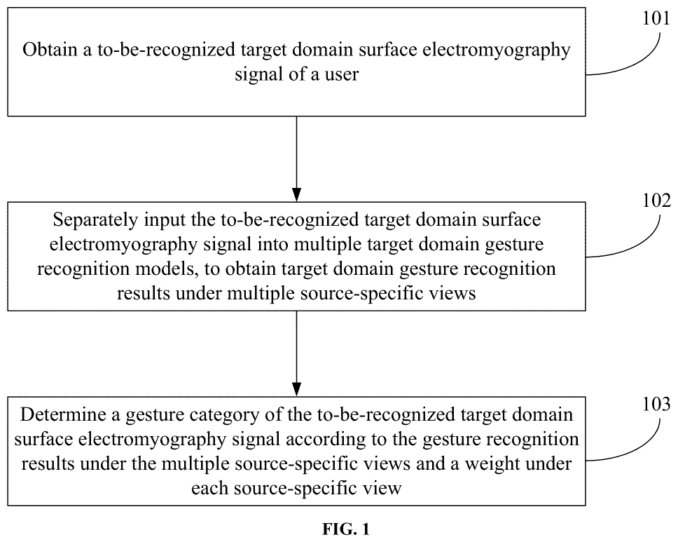

As shown in FIG. 1, this embodiment provides a domain adaptation method for gesture recognition, including the following steps.
Step 101. Obtain a to-be-recognized target domain surface electromyography signal of a user.
Step 102. Separately input the to-be-recognized target domain surface electromyography signal into multiple target domain gesture recognition models, to obtain target domain gesture recognition results under multiple source-specific views, where the target domain gesture recognition models are in one-to-one correspondence with the source-specific views, a target domain gesture recognition model corresponding to any source-specific view is constructed based on a source domain gesture recognition model of a corresponding source domain and a domain adaption model of a corresponding source-specific view, the source domain gesture recognition model is obtained by training an initial source domain gesture recognition model by using multiple surface electromyography signals under a same source domain, the initial source domain gesture recognition model includes a feature extractor and a gesture classifier, the feature extractor includes a convolutional neural network, a recurrent neural network, and multiple fully connected layers, where the convolutional neural network, the recurrent neural network, and the multiple fully connected layers are sequentially connected, the gesture classifier includes a fully connected layer and a softmax classifier, the fully connected layer in the gesture classifier includes multiple hidden units, the domain adaption model includes a target domain feature encoder and a domain discriminator, a neural network structure of the target domain feature encoder is the same as a neural network structure of a corresponding source domain feature extractor, and the target domain gesture recognition model includes a trained target domain feature encoder and a trained gesture classifier that correspond to a same source domain.
Step 103. Determine a gesture category of the to-be-recognized target domain surface electromyography signal according to the gesture recognition results under multiple source-specific views and a weight under each source-specific view.

Before step 101, the method further includes the following steps.
Step 104. Obtain training surface electromyography signals from multiple subjects, to form a training surface electromyography signal data set, where multiple pieces of training surface electromyography signal data of a same subject in the training surface electromyography signal data set are considered as data under a same source-specific view.
Step 105. Perform label marking on a gesture category corresponding to each frame in multiple training surface electromyography signals in the training surface electromyography signal data set.
Step 106. Construct multiple initial source domain gesture recognition models.
Step 107. Determine any source domain as a current source domain.
Step 108. Train any initial source domain gesture recognition model by using multiple pieces of training surface electromyography signal data of the current source domain as input and by using labels of gesture categories corresponding to multiple pieces of training surface electromyography signal data of the current source domain as output, to obtain a current source domain gesture recognition model.

The step 108 includes the following steps.
Step 1081. Determine any initial source domain gesture recognition model as a current initial source domain gesture recognition model.
Step 1082. Determine a feature extractor in the current initial source domain gesture recognition model as a current feature extractor.
Step 1083. Determine a gesture classifier in the current initial source domain gesture recognition model as a current gesture classifier.
Step 1084. Input multiple training surface electromyography signals under the current source domain into the current feature extractor to obtain multiple current source domain surface electromyography signal deep features, where the current source domain surface electromyography signal deep feature is an output result of the current feature extractor.
Step 1085. Input multiple current source domain surface electromyography signal deep features into the current gesture classifier to obtain gesture classification results, where the gesture classification result includes a probability that any current source domain surface electromyography signal is each gesture category.

After step 108, the method further includes the following steps.
Step 109. Construct a current target domain feature encoder according to a network structure of the trained current feature extractor.
Step 1010. Construct a current domain discriminator by using a parameter of the trained current feature extractor as an initial parameter.
Step 1011. Input multiple pieces of training surface electromyography signal data of the current source domain into the current target domain feature encoder for encoding, to generate multiple deep encoded features of multiple pieces of training surface electromyography signal data under a current source-specific view.
Step 1012. Input multiple deep encoded features of same training surface electromyography signal data and multiple deep encoded features into the current domain discriminator for distinguishing, and update parameters of the current target domain feature encoder and the current domain discriminator according to a distinguishing result.

Before step 101, the method further includes the following steps.
Step 109. Determine the weight under each source-specific view.

For example, step 109 includes the following steps.
Step 1091. Determine a distribution followed by multiple current source domain surface electromyography signal deep features as a first distribution.
Step 1092. Determine a distribution followed by multiple target domain surface electromyography signal deep features under the current source domain as a second distribution.
Step 1093. Determine a wasserstein distance between the first distribution and the second distribution.
Step 1094. Determine a weight under the current source-specific view according to the wasserstein distance by using a formula

$${ω}_{i} = {e}^{- \frac{{( {V}_{i}^{T} )}^{2}}{2}} ,$$

where ωᵢ represents a weight under an i^{th} source-specific view, and Vᵢ^{T} represents a wasserstein distance corresponding to an i^{th} source domain.

Specifically, the gesture category of the to-be-recognized target domain surface electromyography signal is

$${y}_{j}^{′ T} = arg max ( {\sum }_{i = 1}^{k} {ϖ}_{i} {C}_{i}^{T} ( {F}_{i}^{T} ( {x}_{j}^{′ T} ) ) )$$

where y′ⱼ^{T} represents the gesture category of the to-be-recognized target domain surface electromyography signal, ω̅ᵢ represents a weight under an i^{th} source-specific view, k represents a total quantity of source domains, and Cᵢ^{T}(Fᵢ^{T}(x′ⱼ^{T})) represents a discrimination result of a target domain surface electromyography signal deep feature (Fᵢ^{T}(x′ⱼ^{T}) of a j^{th} target domain surface electromyography signal x′ⱼ^{T} under the i^{th} source-specific view.

### Embodiment 2

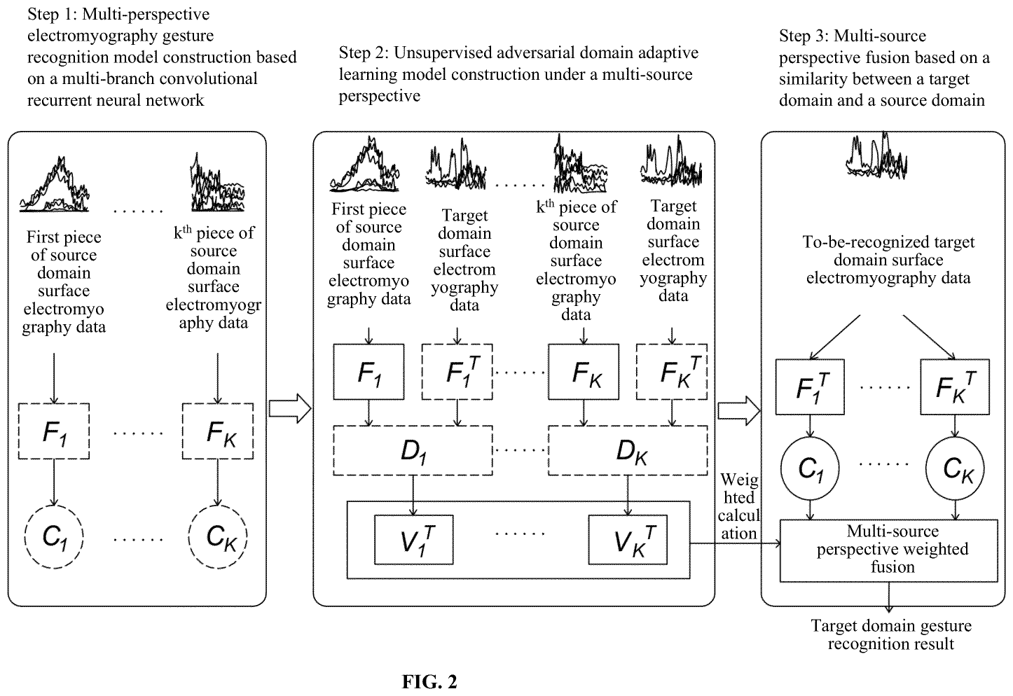

As shown in FIG. 2, this embodiment provides an unsupervised multi-view adversarial domain adaption learning framework for electromyography gesture recognition, which is applicable to the domain adaptation method for gesture recognition provided in Embodiment 1. A construction process of the unsupervised multi-view adversarial domain adaption learning framework for electromyography gesture recognition includes three main steps of multi-view electromyography gesture recognition model construction based on a multi-branch convolutional recurrent neural network, unsupervised adversarial domain adaption learning model construction under a multi-source view, and multi-source view fusion based on a similarity between a target domain and a source domain.

### 1. Multi-View Electromyography Gesture Recognition Model Construction Based on a Multi-Branch Convolutional Recurrent Neural Network

It is assumed that a training data set includes a surface electromyography data sample set (X₁^{S}, X₂^{S}, . . . , Xₖ^{S}), belonging to K source domains (S₁, S₂, . . . , and Sₖ), where Xᵢ^{S}={xⱼ^{S}, yⱼ^{S}}ⱼ₌₁^{N}^{ᵢ}^{^{S}}, xⱼ^{S} represents a surface electromyography data sample in the source domain, yⱼ^{S} represents a gesture action label corresponding to xⱼ^{S}, and Nᵢ^{S} represents a total quantity of surface electromyography data samples in the source domain. A multi-view electromyography gesture recognition model including k deep neural network branches is constructed and is configured to perform feature learning and gesture classification under different independent source-specific views. Each deep neural network branch is formed by a source domain feature extractor Fᵢ and a source domain gesture classifier Cᵢ and is pre-trained by using surface electromyography data with a label of a source domain corresponding to the deep neural network branch. In the pre-training process, deep neural network branches corresponding to different source domains do not share a neural network parameter, to ensure that optimal solutions of parameters of Fᵢ and Cᵢ can be obtained under source-specific views corresponding to the deep neural network branches.

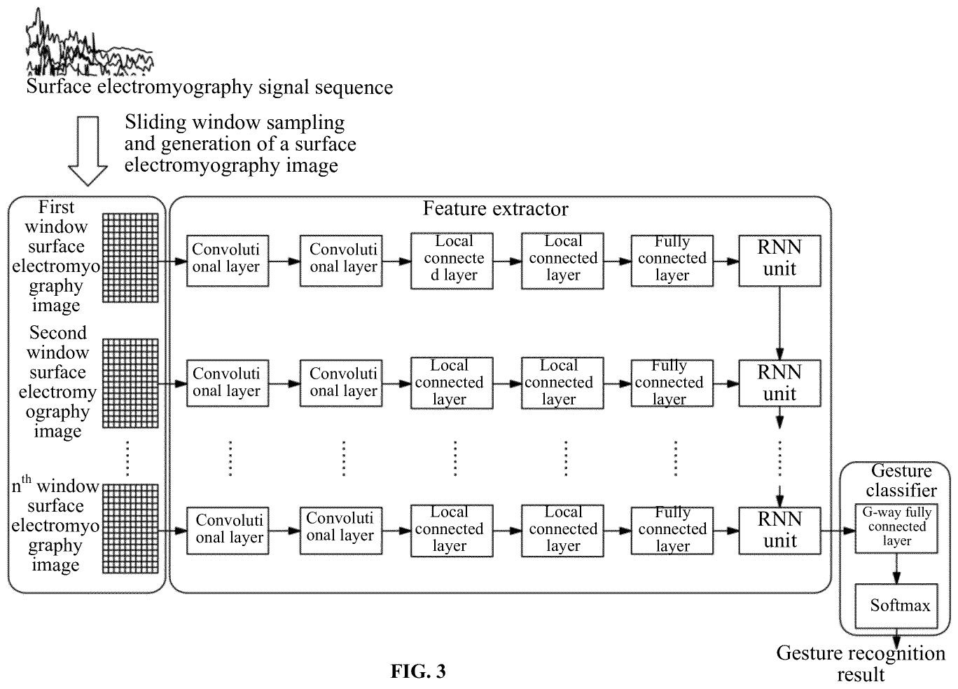

Surface electromyography is essentially a time sequence, to more effectively perform time sequence modeling on surface electromyography data of each source domain, in this embodiment, a structure of each neural network branch in the multi-view electromyography gesture recognition model is designed based on a convolutional recurrent neural network (CRNN). As shown in FIG. 3, a source domain feature extractor Fᵢ(i=1, 2, . . . , and k) in each deep neural network branch is formed by connecting a convolutional neural network (CNN), a recurrent neural network (RNN), and multiple fully connected layers. The recurrent neural network is a neural network having a time sequence memory ability, and constructs a hidden unit having a self-feedback structure on each time point of a sequence. Feedback of each hidden unit not only enters an output end, but also enters a hidden unit of a next time point. Output of a hidden unit of each time point of the network is not only related to input of the hidden unit and a weight of the network, but also input of hidden units of all time points before the time point.

As shown in FIG. 3, an electromyography gesture recognition process under each source- specific view in the multi-view electromyography gesture recognition model is described as follows. Sliding window sampling is first performed on each segment of surface electromyography signal sequence, then surface electromyography signals of M frames and L channels in each sliding sampling window are normalized into an interval [0, 1] and then converted into an M*L surface electromyography image, the surface electromyography image is inputted into a convolutional neural network formed by a convolutional layer and a local connected layer for feature learning, a convolutional feature learned by the convolutional neural network is mapped to a vector space by using a fully connected layer, and then a deep feature in a form of a vector outputted by the fully connected layer is inputted into a recurrent neural network (RNN) unit. Each sliding sampling window is considered as a time point in a time sequence. A surface electromyography signal xₜ of each sliding sampling window is associated with a surface electromyography signal xₜ₋₁ of a previous time point (a sliding sampling window) and a surface electromyography signal xₜ₊₁ of a next time point (a sliding sampling window) by using a RNN unit with a self-feedback structure, so that the RNN may perform time series modeling on a surface electromyography signal sequence and output a learned time sequence feature outputted by using a last RNN unit. The outputted time sequence feature is inputted into a gesture classifier formed by a fully connected layer (a G-way fully connected layer) of G hidden units and a softmax classifier for gesture recognition, and a gesture classification result in a form of a probability of each gesture category is outputted, where G is equal to a total quantity of gesture action categories.

### 2. Unsupervised Adversarial Domain Adaption Learning Model Construction Under a Multi-Source View

In electromyography gesture recognition, a goal of multi-source unsupervised domain adaption learning is to minimize a distribution difference between different source domains and a target domain and construct a machine learning model that can perform a gesture recognition task in the target domain in a case that the surface electromyography data sample (X₁^{S}, X₂^{S}, . . . , Xₖ^{S}), with a label belonging to k source domains (S₁, S₂, . . . , and Sₖ) and a surface electromyography data sample set X^{T}={xⱼ^{T}}ⱼ₌₁^{N}^{^{T}} without a label belonging to some target domains are known. To achieve this goal, in this embodiment, unsupervised adversarial domain adaption learning is performed under different independent source-specific views, and an unsupervised adversarial domain adaption learning model under a multi-source view is constructed, so that target domain electromyography gesture recognition performance can be effectively improved by using an optimal source domain deep feature learned under different source-specific views.

As shown in FIG. 2, for each source domain Sᵢ, a target domain feature encoder Fᵢ^{T} and a domain discriminator Dᵢ is first established under a Sᵢ view. Under the source domain Sᵢ view, the target domain feature encoder Fᵢ^{T} and the source domain feature extractor Fᵢ have a same neural network structure, and a parameter of Fᵢ is used as an initial parameter. The target domain feature encoder encodes target domain electromyography data X^{T}, to generate a deep feature Fᵢ^{T}(X^{T}) of the target domain electromyography data under the source domain Sᵢ view. The domain discriminator Dᵢ accepts Fᵢ^{T}(X^{T}) and a deep feature Fᵢ(Xᵢ^{S}) learned by the source domain feature extractor Fᵢ from electromyography data of the source domain Sᵢ, and tries to determine domains to which the Fᵢ^{T}(X^{T}) and the deep feature belong. When Dᵢ correctly determines that Fᵢ^{T}(X^{T}) is from a target domain, the target domain feature encoder Fᵢ^{T} tries to enable Fᵢ^{T}(X^{T}) to be more approximate to Fᵢ(Xᵢ^{S}) by updating a parameter, increasing a probability that Dᵢ performs incorrect determining. When Dᵢ is trained, a parameter of Fᵢ^{T} is fixed, and when Fᵢ^{T} is trained, a parameter of Dᵢ is fixed. Through such a cyclic alternating two-player minimax gaming process, both Dᵢ and Fᵢ^{T} can obtain optimal solutions. In this case, the deep feature Fᵢ^{T}(X^{T}) of the target domain electromyography data under the source domain Sᵢ view is similar enough to the deep feature Fᵢ(Xᵢ^{S}) of the source domain Sᵢ electromyography data, so that the domain discriminator Dᵢ cannot determine an accurate source of input of the target domain feature encoder. Through the process, cross-domain knowledge between a source domain and a target domain is migrated under each source-specific view, and the unsupervised adversarial adaptive learning model under the multi-source view is finally formed.

In this embodiment, the domain discriminator and the target domain feature encoder are optimized based on a wasserstein distance. When all domain discriminators meet a 1-Lipschitz continuity (Lipschitz continuity condition) constraint condition, the domain discriminator Dᵢ tries to maximize a wasserstein distance between the deep feature Fᵢ(Xᵢ^{S}) of the source domain Sᵢ electromyography data and the deep feature Fᵢ^{T}(X^{T}) of the target domain electromyography data under the source domain Sᵢ view, to correctly distinguish Fᵢ(Xᵢ^{S}) and Fᵢ^{T}(X^{T}), where a target function may be written as:

$$\text{?} {V}_{i}^{T} = \text{?} [ \text{?} ( \text{?} ( {X}_{i}^{S} ) ) - 1 ] - \text{?} [ {( {D}_{i} ( {F}_{i}^{T} ( {X}^{T} ) ) )}^{2} ] + λ {P}_{grad}$$

$${P}_{grad} = \text{?} [ {( ‖ \text{?} {D}_{i} ( \text{?} ) {‖}_{2} - 1 )}^{2} ]$$

$$\text{?} \text{indicates text missing or illegible when filed}$$

p_{data}(Fᵢ(Xᵢ^{S})) is a distribution followed by the deep feature Fᵢ(Xᵢ^{S}) of the source domain electromyography data, p_{X}_{^{T}}(X^{T}) is a distribution following by the target domain electromyography X^{T}, [symbol] represents mathematic expectation, P_{grad} is a gradient penalty term when the domain discriminator Dᵢ meets the 1-Lipschitz constraint, \hat{X} is a linear random sampling point between every two samples in probability distributions of Fᵢ(Xᵢ^{S}) and Fᵢ^{T}(X^{T}), and λ is a fixed penalty term coefficient.

For the target domain feature encoder Fᵢ^{T}, the target domain feature encoder tries to minimize the wasserstein distance between Fᵢ(Xᵢ^{S}) and Fᵢ^{T}(X^{T}), to increase a probability that the domain discriminator Dᵢ confuses Fᵢ(Xᵢ^{S}) and Fᵢ^{T}(X^{T}). on the premise that the parameter of domain discriminator Dᵢ is fixed, the target function of Fᵢ^{T} is equivalent to:

$${min}_{{F}_{i}^{T}} V ( {F}_{i}^{T} ) = - \text{?} [ {( {D}_{i} ( {F}_{i}^{T} ( {X}^{T} ) ) )}^{2} ]$$

$$\text{?} \text{indicates text missing or illegible when filed}$$

### 3. Multi-Source View Fusion Based on a Similarity Between a Target Domain and a Source Domain

In this embodiment, a target domain gesture recognition model under a multi-source view is constructed based on the unsupervised adversarial domain adaption learning model under the multi-source view, and target domain electromyography gesture classification results under different source-specific views are obtained. As shown in FIG. 3, a target domain gesture recognition model under an i^{th} source domain Sᵢ view is formed by a target domain feature encoder Fᵢ^{T} under the Sᵢ view and a source domain gesture classifier Cᵢ corresponding to Si. Fᵢ^{T} is configured to learn, from new to-be-recognized target domain electromyography data X′^{T}, a deep feature Fᵢ^{T}(X′^{T}) of the to-be-recognized target domain electromyography data under the source domain Sᵢ view, and then Fᵢ^{T}(X′^{T}) is inputted into Cᵢ for gesture classification, to obtain a target domain gesture classification result under the source domain Sᵢ view.

Through the process, when new to-be-recognized target domain electromyography data X′^{T} is inputted into the mode, target domain gesture classification results under k source domain S₁, S₂, S₃, . . . , and Sₖ views are finally obtained. In this embodiment, weighted fusion is performed on the k source-specific views, to obtain a final target domain gesture classification result. It is assumed that a j^{th} data sample in the new to-be-recognized target domain electromyography data X′^{T} is x′ⱼ^{T}, a calculation formula of a gesture category soft label y′ⱼ^{T} of the j^{th} data sample is:

$${y}_{j}^{′ T} = arg max ( {\sum }_{i = 1}^{k} {ϖ}_{i} {C}_{i}^{T} ( {F}_{i}^{T} ( {x}_{j}^{′ T} ) ) )$$

where ω̅(i=1,2,3 . . . ,k) are weights under different source-specific views. Research on multi-source domain adaption learning has shown that classification results from source domains that are more similar to the target domain are more credible. Therefore, in this embodiment, the weights under different source-specific views are determined based on a similarity between a target domain and a source domain, to emphasize the view of the source domain that is highly similar to the target domain in the fusion of multi-source views. In this embodiment, similarities between a target domain and different source domains are measured based on a wasserstein distance and a confusion score, to determine weights of different source domains.
(1) Method for calculating a weight under a source-specific view based on a wasserstein distance:

$${ω}_{i} = {e}^{- \frac{{( {V}_{i}^{T} )}^{2}}{2}} ,$$

where Vᵢ^{T} is a wasserstein distance between a deep feature of i^{th} source domain Sᵢ electromyography data and a deep feature of target domain electromyography data under a Sᵢ view.
(2) Method for calculating a weight under a source-specific view based on a confusion score:

$${ω}_{i} = \frac{{𝒮}_{cf} ( {x}^{T} ; F , {D}_{i} )}{{\sum }_{j = 1}^{k} {𝒮}_{cf} ( {x}^{T} ; F , {D}_{j} )}$$

$${𝒮}_{cf} ( {x}^{T} ; F , {D}_{i} ) = - log ( 1 - {D}_{i} ( {F}_{i}^{T} ( {X}^{T} ) ) ) + {α}_{i}$$

where αᵢ is a discrimination loss average value of a domain discriminator Dᵢ on all samples in a source domain Sᵢ, and S_{cf}(x^{T};F,Dᵢ) is a confusion score. S_{cf}(x^{T};F,Dᵢ) is target domain data, F is a feature extractor, and the domain discriminator Dᵢ is a domain discriminator based on the source domain Sᵢ. For inputted data x (where x is from the source domain Sᵢ or a target domain), the feature extractor extracts a feature F(x) and inputs the feature into the domain discriminator Dᵢ, and the domain discriminator Dᵢ classifies and determines whether F(x) is from the source domain Sᵢ or the target domain. For the data from the source domain Sᵢ, another source domain discriminator is not used. For the data from the target domain, a domain discriminator Dᵢ generates N source domain discrimination results {Dᵢ(F(x^{T}))}ᵢ₌₁^{N} for updating the domain discriminator Dᵢ.

### Embodiment 3

This embodiment provides a gesture recognition-domain adaption system, including the following modules.

A to-be-recognized target domain surface electromyography signal acquisition module is configured to obtain to-be-recognized target domain surface electromyography signals of users.

A gesture recognition result determining module is configured to separately input the to-be-recognized target domain surface electromyography signals into multiple target domain gesture recognition models, to obtain target domain gesture recognition results under multiple source-specific views, where the target domain gesture recognition models are in one-to-one correspondence with the source-specific views, and a target domain gesture recognition model corresponding to any source-specific view is constructed based on a source domain gesture recognition model of a corresponding source domain and a domain adaption model of a corresponding source-specific view.

A gesture category determining module is configured to determine gesture categories of the to-be-recognized target domain surface electromyography signals according to the gesture recognition results under multiple source-specific views and a weight under each source-specific view.

The source domain gesture recognition model is obtained by training an initial source domain gesture recognition model by using multiple surface electromyography signals under a same source domain, the initial source domain gesture recognition model includes a feature extractor and a gesture classifier, the feature extractor includes a convolutional neural network, a recurrent neural network, and multiple fully connected layers, where the convolutional neural network, the recurrent neural network, and the multiple fully connected layers are sequentially connected, the gesture classifier includes a fully connected layer and a softmax classifier, the fully connected layer in the gesture classifier includes multiple hidden units, the domain adaption model includes a target domain feature encoder and a domain discriminator, a neural network structure of the target domain feature encoder is the same as a neural network structure of a corresponding source domain feature extractor, and the target domain gesture recognition model includes a trained target domain feature encoder and a trained gesture classifier that correspond to a same source domain.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A domain adaptation method for gesture recognition, comprising:
obtaining a to-be-recognized target domain surface electromyography signal of a user;
separately inputting the to-be-recognized target domain surface electromyography signal into multiple target domain gesture recognition models, to obtain target domain gesture recognition results under multiple source-specific views, wherein the target domain gesture recognition models are in one-to-one correspondence with the source-specific views, and a target domain gesture recognition model corresponding to any source-specific view is constructed based on a source domain gesture recognition model of a corresponding source domain and a domain adaption model of a corresponding source-specific view; the source domain gesture recognition model is obtained by training an initial source domain gesture recognition model by using multiple surface electromyography signals under a same source domain; the initial source domain gesture recognition model comprises a feature extractor and a gesture classifier; the feature extractor comprises a convolutional neural network, a recurrent neural network, and multiple fully connected layers, wherein the convolutional neural network, the recurrent neural network, and the multiple fully connected layers are sequentially connected; the gesture classifier comprises a fully connected layer and a softmax classifier; and the fully connected layer in the gesture classifier comprises multiple hidden units; the domain adaption model comprises a target domain feature encoder and a domain discriminator; a neural network structure of the target domain feature encoder is the same as a neural network structure of a corresponding source domain feature extractor; and the target domain gesture recognition model comprises a trained target domain feature encoder and a trained gesture classifier that correspond to a same source domain; and
determining a gesture category of the to-be-recognized target domain surface electromyography signal according to the gesture recognition results under multiple source-specific views and a weight under each source-specific view.

2. The domain adaptation method for gesture recognition according to claim 1, wherein before the obtaining a to-be-recognized target domain surface electromyography signal of a user, the method further comprises:
obtaining training surface electromyography signals from multiple subjects, to form a training surface electromyography signal data set, wherein multiple pieces of training surface electromyography signal data of a same subject in the training surface electromyography signal data set are considered as data under a same source-specific view;
performing label marking on a gesture category corresponding to each frame in multiple training surface electromyography signals in the training surface electromyography signal data set;
constructing multiple initial source domain gesture recognition models;
determining any source domain as a current source domain; and
training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model.

3. The domain adaptation method for gesture recognition according to claim 2, wherein the training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model comprises:
determining any one of the initial source domain gesture recognition models as a current initial source domain gesture recognition model;
determining a feature extractor in the current initial source domain gesture recognition model as a current feature extractor;
determining a gesture classifier in the current initial source domain gesture recognition model as a current gesture classifier;
inputting multiple training surface electromyography signals under the current source domain into the current feature extractor to obtain multiple current source domain surface electromyography signal deep features, wherein the current source domain surface electromyography signal deep feature is an output result of the current feature extractor; and
inputting multiple current source domain surface electromyography signal deep features into the current gesture classifier to obtain gesture classification results, wherein the gesture classification result comprises a probability that any current source domain surface electromyography signal is each gesture category.

4. The domain adaptation method for gesture recognition according to claim 1, wherein before the obtaining a to-be-recognized target domain surface electromyography signal of a user, the method further comprises:
determining the weight under each source-specific view.

5. The domain adaptation method for gesture recognition according to claim 3, wherein after the training any one of the initial source domain gesture recognition models by using multiple pieces of training surface electromyography signal data of the current source domain as input and by using labels of gesture categories corresponding to multiple pieces of training surface electromyography signal data of the current source domain as output, to obtain a current source domain gesture recognition model, the method further comprises:
constructing a current target domain feature encoder according to a network structure of the trained current feature extractor;
constructing a current domain discriminator by using a parameter of the trained current feature extractor as an initial parameter;
inputting multiple pieces of training surface electromyography signal data of the current source domain into the current target domain feature encoder for encoding, to generate multiple deep encoded features of multiple pieces of training surface electromyography signal data under a current source-specific view; and
inputting multiple deep encoded features of same training surface electromyography signal data and multiple deep encoded features into the current domain discriminator for distinguishing, and updating parameters of the current target domain feature encoder and the current domain discriminator according to a distinguishing result.

6. The domain adaptation method for gesture recognition according to claim 5, wherein the determining the weight under each source-specific view comprises:
determining a distribution followed by multiple current source domain surface electromyography signal deep features as a first distribution;
determining a distribution followed by multiple target domain surface electromyography signal deep features under the current source domain as a second distribution;
determining a wasserstein distance between the first distribution and the second distribution; and
determining a weight under the current source-specific view according to the wasserstein distance by using a formula
$${ω}_{i} = {e}^{- \frac{{( {V}_{i}^{T} )}^{2}}{2}} ,$$
wherein ωᵢ represents a weight under an i^{th} source-specific view, and Vᵢ^{T} represents a wasserstein distance corresponding to an i^{th} source domain.

7. The domain adaptation method for gesture recognition according to claim 1, wherein the gesture category of the to-be-recognized target domain surface electromyography signal is
$${y}_{j}^{′ T} = arg max ( {\sum }_{i = 1}^{k} {ϖ}_{i} {C}_{i}^{T} ( {F}_{i}^{T} ( {x}_{j}^{′ T} ) ) )$$
wherein y′ⱼ^{T} represents the gesture category of the to-be-recognized target domain surface electromyography signal, ω̅ᵢ represents a weight under an i^{th} source-specific view, k represents a total quantity of source domains, and Cᵢ^{T}(Fᵢ^{T}(x′ⱼ^{T})) represents a discrimination result of a target domain surface electromyography signal deep feature (Fᵢ^{T}(x′ⱼ^{T}) of a j^{th} target domain surface electromyography signal x′ⱼ^{T} under the i^{th} source-specific view.

8. A domain adaptation system for gesture recognition, comprising:
a to-be-recognized target domain surface electromyography signal acquisition module, configured to obtain a to-be-recognized target domain surface electromyography signal of a user;
a gesture recognition result determining module, configured to separately input the to-be-recognized target domain surface electromyography signal into multiple target domain gesture recognition models, to obtain target domain gesture recognition results under multiple source-specific views, wherein the target domain gesture recognition models are in one-to-one correspondence with the source-specific views, and a target domain gesture recognition model corresponding to any source-specific view is constructed based on a source domain gesture recognition model of a corresponding source domain and a domain adaption model of a corresponding source-specific view; the source domain gesture recognition model is obtained by training an initial source domain gesture recognition model by using multiple surface electromyography signals under a same source domain; the initial source domain gesture recognition model comprises a feature extractor and a gesture classifier; the feature extractor comprises a convolutional neural network, a recurrent neural network, and multiple fully connected layers, wherein the convolutional neural network, the recurrent neural network, and the multiple fully connected layers are sequentially connected; the gesture classifier comprises a fully connected layer and a softmax classifier; and the fully connected layer in the gesture classifier comprises multiple hidden units; the domain adaption model comprises a target domain feature encoder and a domain discriminator; a neural network structure of the target domain feature encoder is the same as a neural network structure of a corresponding source domain feature extractor; and the target domain gesture recognition model comprises a trained target domain feature encoder and a trained gesture classifier that correspond to a same source domain; and
a gesture category determining module, configured to determine a gesture category of the to-be-recognized target domain surface electromyography signal according to the gesture recognition results under multiple source-specific views and a weight under each source-specific view.
